(19) United States
(12) Patent Application Publication
(10) Pub. No.: US 2023/0339780 A1
(43) Pub. Date: Oct. 26, 2023

(54) SYSTEM AND METHOD FOR REGULATING A PURIFICATION STATE OF TAP WATER

(71) Applicant: Bluewater Sweden AB, Stockholm (SE)

(72) Inventor: Bengt RITTRI, Stockholm (SE)

(21) Appl. No.: 18/008,547

(22) PCT Filed: Jun. 8, 2021
(86) PCT No.: PCT/EP2021/065353

§ 371 Date: Dec. 6, 2022

(30) Foreign Application Priority Data
Jun. 9, 2020 (SE) 2050678-8

(51) Int. Cl. C02F 1/00; C02F 1/44; B01D 61/08; B01D 61/02; B01D 61/12

(52) U.S. Cl. CPC C02F 1/008; C02F 1/441; B01D 61/081; B01D 61/025; B01D 61/12; C02F 2209/40; C02F 2209/008; C02F 2201/005; C02F 2307/06

(57) ABSTRACT

A system configured to deliver water in different purification states. A water valve selection unit to receive a purified water flow from a water purifier via a first valve and to receive an unpurified water flow from a water source via a second valve. The water valve selection unit to direct a water flow including one of the purified water and the unpurified water through an exit portion. A tap to receive the water flow from the exit portion, and to deliver the water flow to a user. A control unit to control the water valve selection unit to regulate a purification state of the flow. The control unit to inform the user of the purification state of the flow delivered by the tap. The water valve selection unit includes a measuring element to measure a volume of the flow that passes the exit portion.

### TECHNICAL FIELD

The invention belongs to the technical field of water purification. More specifically, the present invention belongs to the technical field of delivering purified water to a user.

### BACKGROUND

In water purification systems water from a source of a contaminated/polluted/unpurified origin is directed through a water purifier to create drinkable water. There are several different water purifiers and water treatments available in the prior art, one example of such a water treatment used is reverse osmosis. Reverse osmosis works by forcing untreated water molecules through a semi-permeable filter membrane. The filter membrane blocks contaminants and the impurities are subsequently expelled from the environment. This works effectively in cleansing the water from contaminations and substances not wanted in drinking water.

The purified water is then sent through pipes to a tap for using, e.g. drinking. In prior art, the typical setup has one tap for unpurified water and one separate tap for the purified water. A user then uses one tap if drinkable water is needed, and one tap if unpurified water may suffice. Having separate taps ensures a user that the water is of wanted purification level. However, not knowing which tap brings purified and unpurified water respectively gives the risk that a user might drink contaminated water by mistake.

The solution proposed by prior art is both impractical and invasive in existing kitchen designs, there is a need for improvements to existing systems delivering purified water.

### SUMMARY

The inventors have reached the insight that having two separate taps causes problems when installing such a system in already built kitchens. They have also realized the issue with the risk of drinking contaminated water. They have reached the conclusion that a system that uses only one tap to deliver both purified and unpurified water is possible. This insight has caused the inventors to develop the invention disclosed in this document. The invention includes a way for the user to be ensured that the water obtained is of the wanted purification level without having separately installed taps which diminishes the risk of drinking unpurified water.

The invention disclosed within may be used with any water purification system and may also be used with future enhanced versions of already commercially available water purifiers. Water purifiers or water treatment systems are important for delivering a drinkable water flow from water sources with undrinkable water, such as for example lakes or contaminated wells. An example of a water purification system that may be used with the invention is a system based on Reverse Osmosis (RO). RO is a water treatment method traditionally known for removing salt from seawater, it is also used to purify drinking water by forcing untreated water molecules through a semi-permeable filter membrane. The filter membrane blocks contaminants and the impurities are subsequently expelled from the environment. RO is a process where a weaker saline solution will tend to migrate to a strong saline solution; that is, a solution that is less concentrated will have a natural tendency to migrate to a solution with a higher concentration. Reverse osmosis occurs when the solution is moved across a filter membrane against the concentration gradient, from lower concentration to higher concentration. Using RO for water treatment may have multiple benefits including getting pure, clean drinking water, removal of unwanted odors or tastes. Other types of water treatment systems may be used together with the invention. The end goal of the water treatment systems used with the invention may be to produce and deliver drinkable water. But it may also be to treat water for use in certain other purposes including medical, pharmacological, chemical, industrial applications or any commercial application.

As described above, prior art often provides two taps for respectively delivering purified and unpurified water to a user. This may be impractical to install, provide a risk of drinking contaminated water and need more components and thus be more expansive and less environmentally friendly. It is an object of the present invention to mitigate, alleviate or eliminate one or more of the above identified deficiencies in the prior art.

According to a first aspect of the present invention there is provided a system configured to deliver water in different purification states. The system comprising a water valve selection unit configured to receive a purified water flow from a water purifier via a first valve and to receive an unpurified water flow from a water source via a second valve. Said water valve selection unit is further configured to direct a water flow comprising one of said purified water flow and said unpurified water flow through an exit portion. The system further comprises a tap configured to receive said water flow from said exit portion, and to deliver said water flow to a user. The system further comprises a control unit configured to control said water valve selection unit to regulate a purification state of said water flow. Said control unit is further configured to inform said user of said purification state of said water flow delivered by said tap. And said water valve selection unit comprises a measuring element configured to measure a volume of said water flow that passes said exit portion.

According to a second aspect of the present invention there is provided a method for controlling a purification state of tap water using a system according the first aspect of the present invention. The method comprises receiving a purified water flow from a water purifier and an unpurified water flow from a water source at a water valve selection unit. The method further comprises delivering a water flow comprising one of said purified water flow and said unpurified water flow from said water valve selection unit to a tap. The method further comprises delivering said water flow from said tap to a user. The method further comprises controlling a content of said water flow using a control unit configured to control said water valve selection unit to regulate said content of said water flow between said purified water flow and said unpurified water flow. The method further comprises informing a user whether said water flow comprises said purified water flow or said unpurified water flow. And the method further comprises monitoring a volume of the purified water flow that passes through said water valve selection unit.

Thus, the present invention is based on the idea of providing a way to incorporate a flow of water through a tap wherein the purification level of the water flow is controllable by a user. The present invention is further based on the idea of informing the user whether the water received is purified or not. The invention brings many advantages. A first advantage is that it can be installed within already existing kitchens without adding a tap, this allows for a more user-friendly experience and gives less work for installation. The present invention is therefore advantageous in that there is no need to drill a separate hole in a kitchen for fitting a separate tap. It is advantageous in that the tap used may be the one already available in a kitchen in which the system is installed. Further, the system may be installed with already available water purifiers. The option to control the content of the water flow delivered by the tap and being informed of the purification state gives the advantage of a smaller risk of drinking contaminated or unpurified water that might pose a threat to health. Further, having the possibility to at will change between purified water and unpurified water is beneficial in that when unpurified water will suffice the water purifier can be left unused and thus parts such as filter will wear out at a slower rate. The present invention is further advantageous in that monitoring the volume of the purified water can give information on the water purifier used. Parts used in water purifiers, for example a filter used in reverse osmosis, may need changing after purifying a certain volume of water. By monitoring the volume that passes through the water valve selection unit the system will be able to know when such a part of a water purifier needs to be changed. This is advantageous since it ensures a good water quality and makes maintenance easier. It is further advantageous in that it ensures that parts are not exchanged earlier than necessary which is advantageous from an environmental perspective.

The system and method according to the first and second aspect of the invention involves a purification state. By “purification state” it is here meant if the water has passed through a water purifier or water treatment system or not. If it has passed through a water purifier or water treatment system it can be considered to have one specific purification state, if it has not it can be considered to have a different purification state.

The system and method according to the first and second aspect of the invention involves a purified water flow. By “purified water flow” it is here meant a water flow that has passed through a water purifier or water treatment system in order to cleanse, rinse, or treat the water in a way so that it is drinkable, or useable for certain purposes including for example medical, pharmacological, chemical, industrial applications or any commercial applications.

The system and method according to the first and second aspect of the invention further involves an unpurified water flow. By “unpurified water flow” it is hear meant a water flow from a water source that has not passed through a water purifier or gone through a water treatment so that it is drinkable, or useable for certain purposes including for example medical, pharmacological, chemical, industrial applications or any commercial applications.

According to an embodiment of the first aspect of the invention, said control unit controls said water valve selection unit using Bluetooth. The present embodiment is advantageous in that the control unit does not need to be connected to the water valve selection unit via cables. Thus, the control unit may for example be placed on a sink or stuck to a wall or other surface for easy access by a user.

According to another embodiment of the first aspect of the invention, said water valve selection is configured to send a signal to said control unit when said volume exceeds a preset value, wherein said control unit is further configured to inform said user that said volume has exceeded said preset value. The present embodiment is advantageous in that a user can be informed by the control unit when a certain volume has passed through the water valve selection unit. This can indicate that for example a filter of a water purifier needs to be changed or other maintenance of the water purifier is needed to ensure a good water quality and for the system to be able to provide drinkable water. A user may be informed by any conventional way, the control unit may for example change color or send out a sound alerting the user.

According to another embodiment of the first aspect of the invention, said control unit further comprises at least one battery and is configured to inform said user when said battery needs charging. The present embodiment is advantageous in that the control unit does not need to be connected to a power supply unless it is charging. Further it is advantageous in that the control unit may alert the user that the control unit needs charging before the battery is fully discharged. However, the battery of the control unit may further be charged through any conventional or available way, including but not limited to, charging by cable, wireless charging or magnet charging.

According to another embodiment of the first aspect of the invention, said water valve selection unit comprises a regulation button configured to control said water valve selection unit to regulate a purification state of said water flow. The present embodiment is advantageous in that an extra way of changing the content of the water flow delivered by the tap is provided. If the control unit for example is lost or broken or needs charging, changing the purification state of the delivered water is still possible by using the regulation button.

According to another embodiment of the first aspect of the invention, said tap receives a preset volume of said water flow comprising said purified water flow from said water valve selection unit, said preset volume is based on a user input to said control unit and is selected to correspond to the volume of a water container. The present embodiment is advantageous in that automatic filling with purified water of water containers is possible. This is advantageous in that less purified water is wasted and thus for example filters of the water purifier may be used longer and the system becomes more environmentally friendly. Further, it is advantageous in that when the container is filled automatically it frees the user to do other tasks in the meantime. This may be especially advantageous in commercial use such as in restaurants.

According to an embodiment of the second aspect of the invention, the step of controlling is performed via Bluetooth. The present embodiment is advantageous in that the control unit does not need to be connected to the water valve selection unit via any cables. Thus, the control unit may for example be placed on a sink, or stuck to a wall or other surface for easy access

According to another embodiment of the second aspect of the invention, the method further comprises informing said control unit when said volume exceeds a preset value, wherein said control unit is further configured to inform said user that said volume has exceeded said preset value. The present embodiment is advantageous in that a user can be informed by the control unit when a certain volume has passed through the water valve selection unit. This can indicate that for example a filter of a water purifier needs to be changed or other maintenance of the water purifier is needed to ensure a good water quality and for the system to be able to provide drinkable water. A user may be informed by any conventional way, the control unit may for example change color or send out a sound alerting the user.

According to another embodiment of the second aspect of the invention, the method further comprises controlling a content of said water flow using a regulation button coupled to said water valve selection unit configured to control said water valve selection unit to regulate said content of said water flow between said purified water flow and said unpurified water flow. The present embodiment is advantageous in that an extra way of changing the content of the water flow delivered by the tap is provided. If the control unit for example is lost or broken or needs charging, changing the purification state of the delivered water is still possible by using the regulation button.

According to another embodiment of the second aspect of the invention, the method further comprises the steps of, storing an end purification state comprising information of said content of said water flow upon closing said tap, and delivering a second water flow of said end purification state upon an input to said control unit. By “end purification state” it is meant the purification state of the water flow delivered to a user at the end of a use. For example, if the user receives purified water from the tap and then turns of the water flow the end purification state will correspond to purified water. The present embodiment is advantageous in that it may cut waiting time and save water. If an end purification state is stored between uses, then the user may be able to get water of that purification state with a simple input to the control unit without turning on the tap or involving other parts of the system. This may save water since unnecessary changes between purified and unpurified water may be avoided.

### BRIEF DESCRIPTION OF THE DRAWINGS

The above object, as well as additional objects, features and advantages of the present invention, will be more fully appreciated by reference to the following illustrative and non-limiting detailed description of preferred embodiments of the present invention, when taken in conjunction with the accompanying drawings, wherein:

FIG. 1 schematically illustrates a system according to one possible embodiment of the present invention.

FIG. 2 schematically illustrates a method for controlling a water purification state according to the present invention.

FIG. 3 schematically illustrates an exemplary control unit used in embodiments of the present invention.

FIG. 4 schematically illustrates an exemplary controller used in embodiment of the present invention.

### DETAILED DESCRIPTION

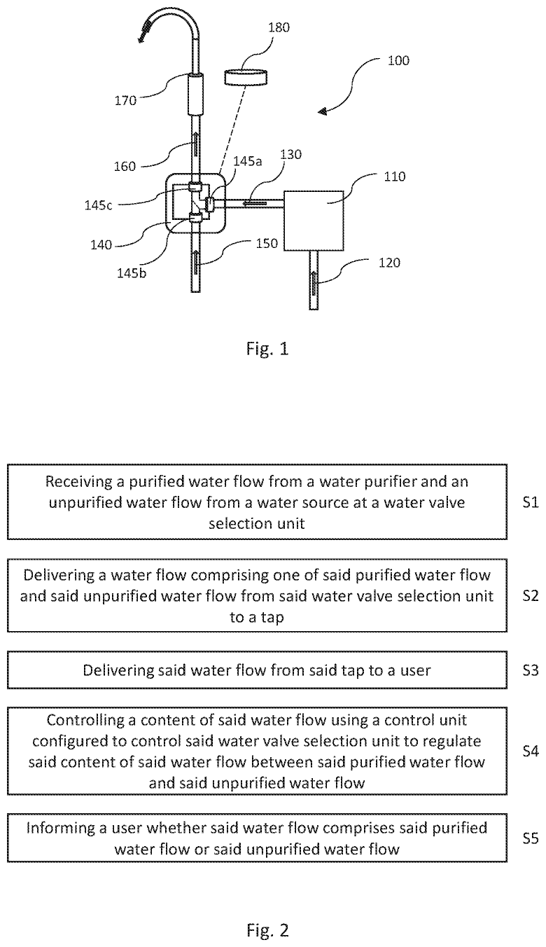

FIG. 1 schematically shows a system 100 according to one embodiment of the present invention. The system 100 in FIG. 1 comprises a water purifier 110 configured to receive a first unpurified water flow 120 from a water source and to deliver a purified water flow 130 to a water valve selection unit 140. The water valve selection unit 140 is further configured to receive a second unpurified water flow 150 from a water source. The water valve selection unit 140 is configured to be able to regulate a content of a water flow 160 to a tap 170. The system further comprises a control unit 180 configured to control the water valve selection unit 140, enabling the regulating feature of the water valve selection 140 changing the content of the water flow 160.

The water valve selection unit 140 may comprise a first valve 145a, a second valve 145b and an exit portion 145c. The purified water flow 130 is received by the water valve selection unit 140 at the first valve 145a. The second unpurified water flow 150 is received by the water valve selection unit 140 at the second valve 145b. The first valve 145a is configured to be open when the second valve 145b is closed and the first valve 145a is configured to be closed when the second valve 145b is open. This allows the water valve selection unit 140 to deliver said water flow 160 comprising of one of the purified water flow 130 and the second unpurified water flow 150 through the exit portion 145c to the tap. If the first valve 145a is open, the water flow 160 comprises the purified water flow 130. And likewise, if the second valve 145b is open, the water flow 160 comprises the unpurified water flow 150.

The control unit 180 may be connected to the water valve selection unit 140 via a cable. The control unit 180 may also be connected to the water valve selection unit 140 via wireless means, for example via a Bluetooth connection. The control unit 180 may be configured to receive a user input from a user in order to change the content of the water flow 160 delivered by the tap 170. This is done by regulating which valve is open of the first valve 145a and the second valve 145b. The control unit 180 may also be configured to inform the user about the purification state of the water flow 160, for example via displaying different colors. The control unit 180 may be configured to act like a button, and upon receiving a button press the control unit 180 may send a signal to the control unit 140 which as a response regulates the water flow 160 by changing its content from the purified water flow 130 to the second unpurified water flow 150 or the other way around. Upon a user input to the controller 180 to regulate the water flow 160 there may be a time delay until the water flow 160 delivered by the tap 170 only comprises water of the wanted purification state. The control unit 180 may be configured to inform the user when this time period has passed, i.e. when the water flow 160 only comprises water of the wanted purification state.

The water purifier 110 disclosed in FIG. 1 may be a part of the system, but it may also not be a part of the system. The purified water flow 130 may be delivered from outside the system and from any type of water purification system. The water purifier 110 may for example be a reverse osmosis water purifier or any other readily available water treatment system.

The water valve selection unit 140 may further comprise a measuring element configured to measure a volume of the water passing through the exit portion 145c. The measuring element may be configured to measure the volume of the purified water flow passing through the exit portion 145c. The water valve selection unit 140 may further be configured to inform the control unit 180 when a preset water volume has been measured by the measuring element. This would be beneficial since it would allow the control unit 180 to inform a user that the water purifier 110 has purified a certain volume, and that attending certain elements within the water purifier 110 may be necessary. In other embodiments of the invention the water valve selection unit 140 may be configured to inform other means of communications that said preset water volume has been measured. These other means of communication may include, but not be limited to, certain displays, smartphones or so-called voice-activated helpers such as Siri or Alexa. Any electronic device capable of informing a user that the water purifier 110 has purified a certain volume may be used to be coupled to the water valve selection unit 140 for informing the user when the water purifier 110 needs attending.

FIG. 2 schematically shows a method according to an embodiment of the present invention that for example could be performed by the embodiment of FIG. 1. In a step S1, a purified water flow from a water purifier and an unpurified water flow from a water source is received at a water valve selection unit. In a step S2, a water flow comprising one of the purified water flow and the unpurified water flow is delivered from the water valve selection unit to a tap. In a step S3, the water flow is delivered from the tap to a user. In a step S4, a content of said water flow is controlled using a control unit configured to control the water valve selection unit to regulate said content of the water flow between the purified water flow and the unpurified water flow. In a step S5, a user is informed whether the water flow comprises the purified water flow or the unpurified water flow.

In step S4, the controlling of the water valve selection unit may be done via a Bluetooth connection to the control unit. It may also be done via a cable connection between the two. In step S5, a user may be informed of the content of the water flow from a tap from the control unit by the control of the control unit. For example, if the control unit shines a blue light the water may be purified and if the control unit shines an orange light the water may be unpurified. Other ways of informing a user of the content of the water flow are available and understood by a person skilled in the art. The method disclosed in FIG. 2 could also include more steps, for example monitoring a volume of the purified water flow that passes through the water valve selection unit. This could be done in order to know when a water purifier has treated or purified a set volume of water and thus need attending by a user. When a preset volume is reached, the control unit may be configured to receive this information from the water valve selection unit and deliver it to the user, e.g. by the control unit changing color or any other conventional and easily understood way. Further, the method discloses in FIG. 2 may comprise steps of letting a user set a predetermined water volume to be delivered by the water valve selection unit to the tap for delivery to the user. This may be advantageous in that a water container of a certain volume may be automatically filled without the overseeing by the user. The method disclosed in FIG. 2 may further comprise informing a user if a predetermined volume of purified water has been delivered by the tap. This predetermined volume may for example correspond to the volume a water purifier may purify before attendance is needed. This may be advantageous in that the user will be informed when the water purifier needs attending or maintenance.

The method may in other embodiments further comprise the steps of, storing an end purification state comprising information of said content of said water flow upon closing said tap, and delivering a second water flow of said end purification state upon an input to said control unit. This may be advantageous if a user often uses water of the same purification state. The latest purification state used will be stored and be readily available to the user with a simple input to the control unit. For example, by a single press to the control unit water of the stored end purification state may be delivered to the user. This will be both beneficial due to shorter wait times and less unnecessary water consumption.

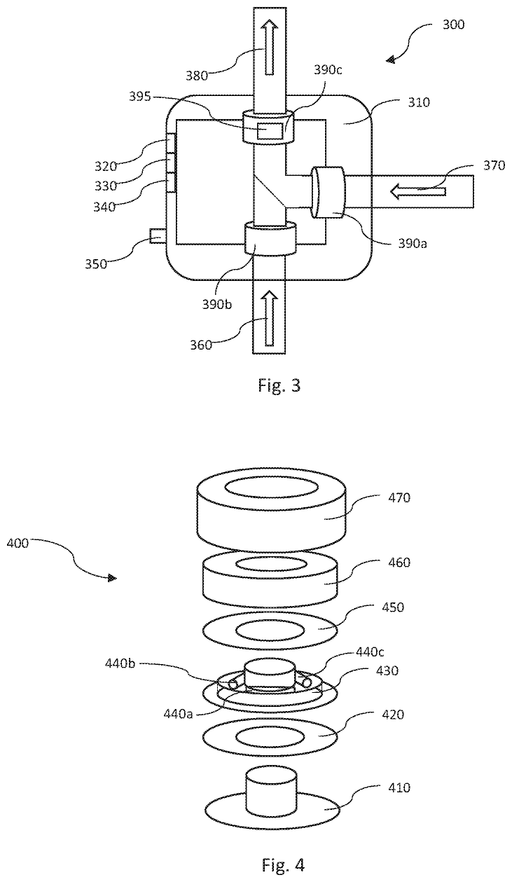

FIG. 3 schematically illustrates an exemplary water valve selection unit 300 used in embodiments of the present invention. The water valve selection unit 300 comprises a casing 310. The water valve selection unit 300 further comprises an indication light 320 showing whether it is operating correctly.

The water valve selection unit is configured to receive a purified water flow 370 via a first valve 390a. It is further configured to receive an unpurified water flow via a second valve 390b. The first valve 390a is configured to be open when the second valve 390b is closed. The first valve 390a is further configured to be closed when the second valve 390b is open. This ensured that only one of said purified water flow 370 and said unpurified water flow 360 is directed through the water valve selection unit 300. The water flow 380 directed via an exit portion 390c comprises either the purified water flow 370 or the unpurified water flow 360 depending on if the first valve 390a is open or the second valve 390b is open. If the first valve 390a is open, the water flow 380 comprises the purified water flow 370. If the second valve 390b is open, the water flow 380 comprises the unpurified water flow 360. The water valve selection unit 300 is further configured to close and open the valves upon user input to a control unit as described within this application.

Further, the water valve selection unit 300 comprises a regulation button 330 configured to regulate opening and closing of the first valve 390a and the second valve 390b and thus regulating the content of the water flow 380 between the purified water flow 370 and the unpurified water flow 360. The regulation button 330 may for example be used in case the control unit fails, breaks or runs out of battery.

The exemplary water valve selection unit 300 depicted in FIG. 3 also comprises a Bluetooth pairing button 340. This may be used to couple said water valve selection unit 300 to a control unit for controlling the content of the water flow 380. The water valve selection unit further comprises a power inlet 350.

The water valve selection unit 300 further comprises a measuring element 395 configured to measure the volume of the water that passes through the exit portion 390c. The measuring element 395 may be configured to measure both or one of the volumes of the unpurified water flow 360 and the purified water flow 370. The volume of the purified water flow 370 is advantageous to measure since many water purifiers contain elements that need changing after a certain amount of usage. A present value of for the volume can be set and when this value is reached by the measuring element 395 the water valve selection unit 300 may inform the control unit that the water purifier needs attending.

A water valve selection unit 300 as described could further contain other kind of measurement elements, such as monitoring a temperature, a pressure, a salt level or other characteristics of the different water flows. The water valve selection unit 300 could further be configured to receive more than two water flows from different sources.

The water valve selection unit 300 may have many different dimensions and shapes and be made of many different materials. It is understood that dimensions small enough for the water valve selection unit 300 to fit under a sink in a given kitchen may be advantageous. Further it is understood that a material that does not contaminate the water is advantageous. For example, a combination of stainless steel and plastic may be used to ensure that the water is not leaking and not being contaminated. Other combinations and materials are of course available to a person skilled in the art. Furthermore, the water valve selection 300 unit may be constructed from molding a material in a certain mold and thus creating all or some of the parts described above. It may further be constructed by adding all pieces separately. Further it may be constructed using a combination of these two ways, wherein some parts are constructed via the use of a mold and other parts are added in a later stage.

FIG. 4 schematically illustrates an exemplary control unit 400 used in embodiments of the present invention. The control unit 400 can have a variety of shapes and materials and a person skilled in the art understands that this is merely one example of many out of possible control units. The control unit 400 in FIG. 4 comprises a bottom plate 410, a pressure plate 420 and a body 430 with three batteries 440a, 440b, 440c placed within the body 430. It is understood that the control unit 400 may comprise any number of batteries and is not limited to three as in this exemplifying embodiment. The control unit 400 further comprises a printed circuit board (PCB) plate 450, a light diffuser 460 and a cover element 470.

The PCB plate 450 may comprise Bluetooth functionality and may be coupled to a water valve selecting unit as described with regards to FIG. 1 or FIG. 3. The control unit 400 may be configured to act like a button and upon a downwards press send a command to said water valve selecting unit to change the purification state of a water flow. The PCB plate 450 may further have RGB LEDs for displaying a color, and this color may be changed depending on the purification state of the water flow sent from the water valve selection unit. The color may inform a user if the water is drinkable or not. The light from the RGB LEDs is directed into the light diffuser 460 and spread across the cover element 470 and displayed to a user. The cover element 470 may be of a transparent material such as glass or plastic. The color change of the RGB LEDs may be a direct change from one color to another, it may also be a gradient change from one color to another depending on the tap used to deliver the water. The control unit 400 should inform the user when the water delivered by the tap is of the wanted purification state, which may include a short waiting time from the downwards press. Thus, including a gradient color change of the RGB LEDs may increase intelligibility of the control unit 400 and diminish the risk of a user drinking contaminated water.

The RGB LEDs of the PCB plate 450 may further be configured to change color when the batteries 440a, 440b, 440c need charging and thus inform a user to charge the control unit 400. The charging of the batteries 440a, 440b, 440c may be done by any available way including, but not limited to, charging via a power cable, wireless charging or magnetic charging. The PCB plate 450 may further be configured to alert the user when the water quality of the purified water is not up to certain standards by changing or flashing a certain color of the RGB LEDs. This may cause the user to examine a water purifier used in combination with the control unit 400 to see if a filter or any other element need changing or attending.

The control unit 400 may have multiple inherit settings such as changing between purified and unpurified water flow, for example by pressing the control unit 400 once. Further, for example pressing the control unit 400 for a longer time period may trigger other settings. One example of such a setting may be automatic filling of a water container, such as a water bottle or a larger industrial water container. By pressing the control unit 400 for a longer time period, for example 3 seconds, the unit may change color indicating a new mode has been entered. By introducing a water bottle or a container to a tap and pressing the control unit 400 again, a preset water volume of purified water may be delivered to the water bottle from the water valve selection unit via the tap. Functionalities such as automatic filling of preset water volumes have advantageous in that it saves water and makes sure that all water that has been purified is used and less water is wasted. This ensured that the water purifier used may be used for longer without service or exchanging for example a filter. It may further be advantageous in industrial use in for example restaurant when filling larger containers. This may save the man power used since the user may conduct other tasks while the water container is automatically filled.

The control unit 400 may also be configured to allow for so called one-click functionality. With one-click functionality it is meant that the system may remember information between uses and this information be reached by a single click. As an example, if a first user uses the system to get unpurified water and then turns off the tap. The purification state of the last delivered water flow may be stored, for example by the control unit. The control unit may therefore be able upon an input deliver water of the stored purification state to a user. For example, the input may be a single press or a one-click and may yield a water flow of the stored purification state without the need for the tap to be opened or closed by the user. The one-click functionality may save both time and mitigate water losses due to changing between the different purification states unnecessarily.

Further, the control unit 400 may also comprise a speaker for sending an audio signal to a user. Different sounds and sound patters may be transmitted by the speaker to indicate any of the situations described above. This may be advantageous in case that a user may be blind and cannot see a color indication of the control unit 400. The skilled person understands that any conventional way of communicating information may be used, for example for communicating to the user the water purification state.

The control unit 400 may be of dimensions suitable for placing on a kitchen-sink, or by magnets or other mounting devices stick to a refrigerator or a wall. The materials of the different elements of the control unit 400 may alter, and the shape and size may differ. It is further understood that the control unit 400 disclosed in FIG. 4 is an exemplary embodiment. The control unit may for example instead be any other electronic equipment such as a smartphone. In the case where the control unit is a smartphone or tablet the functionality of the control unit may be comprised within an application of said smartphone or tablet. Such an application may have all the functionality disclosed herein. For example, the application may display different purification states of the water flow. It may inform a user when a preset volume of purified water has passed through the system to inform a user that maintenance of the water purifier is needed. It may further comprise the above described one-click technology. Also, if the control unit is placed within an application of a smartphone or similar, multiple control units may be used sharing the same information. For example, each member of a family may have access to an application from where controlling the system according to the invention is possible. It is understood by the skilled person that any suitable piece of electronics may be used as a control unit in accordance with present invention.

1. A system configured to deliver water in different purification states, comprising:
a water valve selection unit configured to receive a purified water flow from a water purifier via a first valve and to receive an unpurified water flow from a water source via a second valve wherein said water valve selection unit is further configured to direct a water flow comprising one of said purified water flow and said unpurified water flow through an exit portion,
a tap configured to receive said water flow from said exit portion, and to deliver said water flow to a user,
a control unit configured to control said water valve selection unit to regulate a purification state of said water flow, wherein said control unit is further configured to inform said user of said purification state of said water flow delivered by said tap, and wherein said water valve selection unit comprises a measuring element configured to measure a volume of said water flow that passes said exit portion.

2. The system according to claim 1, wherein said control unit controls said water valve selection unit using Bluetooth.

3. The system according to claim 1, wherein said water valve selection is configured to send a signal to said control unit when said volume exceeds a preset value, wherein said control unit is further configured to inform said user that said volume has exceeded said preset value.

4. The system according to claim 1, wherein said control unit further comprises at least one battery and is configured to inform said user when said battery needs charging.

5. The system according to claim 1, wherein said water valve selection unit comprises a regulation button configured to control said water valve selection unit to regulate a purification state of said water flow.

6. The system according to claim 1, wherein said tap receives a preset volume of said water flow comprising said purified water flow from said water valve selection unit, said preset volume is based on a user input to said control unit and is selected to correspond to the volume of a water container.

7. A method for controlling a purification state of tap water using a system according to claim 1, the method comprising:
receiving a purified water flow from a water purifier and an unpurified water flow from a water source at a water valve selection unit,
delivering a water flow comprising one of said purified water flow and said unpurified water flow from said water valve selection unit to a tap,
delivering said water flow from said tap to a user,
controlling a content of said water flow using a control unit configured to control said water valve selection unit to regulate said content of said water flow between said purified water flow and said unpurified water flow,
informing a user whether said water flow comprises said purified water flow or said unpurified water flow, and
monitoring a volume of the purified water flow that passes through said water valve selection unit.

8. The method according to claim 7, wherein the step of controlling is performed via Bluetooth.

9. The method according to claim 7 further comprising informing said control unit when said volume exceeds a preset value, wherein said control unit is further configured to inform said user that said volume has exceeded said preset value.

10. The method according to claim 7, further comprising controlling a content of said water flow using a regulation button coupled to said water valve selection unit configured to control said water valve selection unit to regulate said content of said water flow between said purified water flow and said unpurified water flow.

11. The method according to claim 7, further comprising the steps of:
storing an end purification state comprising information of said content of said water flow upon closing said tap, and
delivering a second water flow of said end purification state upon an input to said control unit.
